(19) United States
(12) Patent Application Publication
(10) Pub. No.: US 2010/0294145 A1
(43) Pub. Date: Nov. 25, 2010

(54) APPARATUS FOR FEEDING FOIL OF PRINTING MACHINE WITH TENSION

(76) Inventor: Byung-Jun Song, Anyang-si (KR)

Correspondence Address: BIRCH STEWART KOLASCH & BIRCH, PO BOX 747, FALLS CHURCH, VA, 22040-0747, US

(21) Appl. No.: 12/671,124

(22) PCT Filed: Jul. 1, 2008
(86) PCT No.: PCT/KR08/03873

§ 371 Date: Aug. 10, 2010

(30) Foreign Application Priority Data
Jul. 31, 2007 (KR) 10-2007-0077020
Apr. 17, 2008 (KR) 10-2008-0035619

(51) Int. Cl. B41F 19/02

(52) U.S. Cl. 101/27

(57) ABSTRACT

An apparatus for feeding a foil of a printing machine with tension is disclosed, in which vacuum pressure is only applied to a part of a shaft through which a foil passes, and an outer surface in contact with the foil is rotated. The apparatus comprises a cylindrical shaft body provided with a plurality of holes on the outer surface; a sun roller provided based on the center of the shaft body, having a diameter smaller than an inner diameter of the shaft body; a plurality of pinion rollers closely adhered to one another between the sun roller and the inner surface of the shaft body; and a bearing stopper provided to seal both ends of the shaft body and connected with a pump to supply vacuum pressure to only a space formed by the shaft body, the sun roller and two of the pinion rollers.

### TECHNICAL FIELD

The present invention relates to an apparatus for feeding a foil of a printing machine with tension, and more particularly, to an apparatus for feeding a foil of a printing machine with tension, in which vacuum pressure is only applied to a part of a shaft through which a foil passes, and an outer surface in contact with the foil is rotated.

### BACKGROUND ART

A foil printing machine can be manufactured by several types. An example of the types include rotary stamping or rotary diecutting, which prints or diecuts by rolling a foil or diecutting material with a roller. This type is constructed to print or diecut a printing material such as paper through a stamping machine or cutting machine while allowing the printing material to pass through the roller.

Since a conventional printing machine is well-known, its description will be omitted. However, since the present invention is intended to very conveniently and exactly print a foil on a printing material, the foil printing machine will be described.

Since the foil printing machine should continue to feed a processing material, such as a stamping foil, for printing on a paper, the processing material should be supplied intermittently to save the processing material. An example of the conventional foil printing machine is shown in FIG. 1. As shown, a processing material F wound in a storage reel 210 passes through a shaft 212 and is wound in a winding reel 213 as feed rollers 240 and 250 connected to a feed motor are rotated. The processing material F, which has passed through the shaft 211, passes between an impression roller 230 having a die 231 and a lower roller 220 corresponding to the impression roller 230. Since the feed rollers 240 and 250 are rotated in accordance with the feed motor operated only when the die 231 fixed to the impression roller 230 is in contact with the lower roller 220, the processing material F should be rotated intermittently. This is because that the processing material F is wasted if the feed motor is rotated continuously. In this way, the processing material of high cost such as foil can be saved.

### DISCLOSURE OF INVENTION

### Technical Problem

The conventional foil printing machine little has a problem in case of low speed operation. However, if printing is performed at high speed, the conventional foil printing machine has several problems as follows. The feed motor fails to be operated intermittently at high speed due to a weight or inertia of the feed roller. Also, as error occurs, a defect and damage of the processing material are caused. In other words, although the processing material is theoretically fed longer than an arc length L, a problem occurs if printing is performed at high speed.

Furthermore, as illustrated in FIG. 1, according to the conventional foil printing machine, the processing material F wound in the storage reel 210 is wound in the winding reel 213 by passing through the shaft 212 as the feed rollers 240 and 250 connected to the feed motor are rotated. The processing material F, which has passed through the shaft 211, passes between the impression roller 230 having a die 231 and the lower roller 220 corresponding to the impression roller 230. Since the feed rollers 240 and 250 are rotated in accordance with the feed motor operated only when the die 231 fixed to the impression roller 230 is in contact with the lower roller 220, the processing material F should be rotated intermittently in accordance with the length L. This is because that the processing material F is wasted if the feed motor is rotated continuously. In this way, the processing material of high cost such as foil can be saved. According to the conventional art, the processing material wound in the reel is unwound by rotation of the rollers and the dies. In this case, although not shown, mechanisms for maintaining tension applied to the processing material should be provided. Examples of the mechanisms for adjusting tension of the foil, i.e., the processing material, include shafts, which generally provide vacuum pressure. However, since it is difficult for the shafts to adjust tension exactly, problems occur in that the foil is damaged by tension applied thereto and the foil is prevented from freely moving.

### Technical Solution

Accordingly, the present invention is directed to an apparatus for feeding a foil of a printing machine with tension, which substantially obviates one or more problems due to limitations and disadvantages of the related art.

An object of the present invention is to provide an apparatus for feeding a foil of a printing machine with tension, in which vacuum pressure is only applied to a part of an arc of a shaft and an outer surface of the shaft is rotated to easily adjust tension applied to the foil.

An apparatus for feeding a foil of a printing machine with tension according to the present invention comprises a cylindrical shaft body provided with a plurality of holes on the outer surface; a sun roller provided based on the center of the shaft body, having a diameter smaller than an inner diameter of the shaft body; a plurality of pinion rollers closely adhered to one another between the sun roller and the inner surface of the shaft body; and a bearing stopper provided to seal both ends of the shaft body and connected with a pump to supply vacuum pressure to only a space formed by the shaft body, the sun roller and two of the pinion rollers.

The pinion rollers are provided at an angle of 120 and the number of them is three.

Furthermore, the shaft body is made of metal, and the rollers are made of rubber.

Meanwhile, an apparatus for feeding a processing material of a printing machine according to the present invention, the printing machine performing printing or diecutting as the processing material unwound from a storage reel passes between an impression roller attached with a die and a lower roller corresponding to the impression roller, comprises a feed roller provided with a die driven at the same circumferential speed as that of the impression roller and the lower roller.

The feed roller is provided on the same shaft line as that of the impression roller.

### Advantageous Effects

Since an apparatus for feeding a foil of a printing machine with tension according to the present invention can easily adjust tension applied to the foil, it is possible to prevent the foil from being damaged and well adapt to a printing procedure of high speed.

### BRIEF DESCRIPTION OF THE DRAWINGS

FIG. 1 is a schematic view illustrating a conventional printing machine;

FIG. 2 is a schematic view illustrating a printing machine according to the present invention;

FIG. 3 is a perspective view illustrating a shaft of an apparatus for feeding a foil of a printing machine with tension according to the present invention;

FIG. 4 is a sectional view illustrating the shaft shown in FIG. 3;

FIG. 5 is a longitudinal sectional view illustrating an apparatus for feeding a foil of a printing machine with tension according to the present invention;

FIG. 6 is a sectional view illustrating a shaft of an apparatus for feeding a foil of a printing machine with tension according to another embodiment of the present invention; and

FIG. 7 is a diagram illustrating an apparatus for feeding a foil of a printing machine with tension according to another embodiment of the present invention.

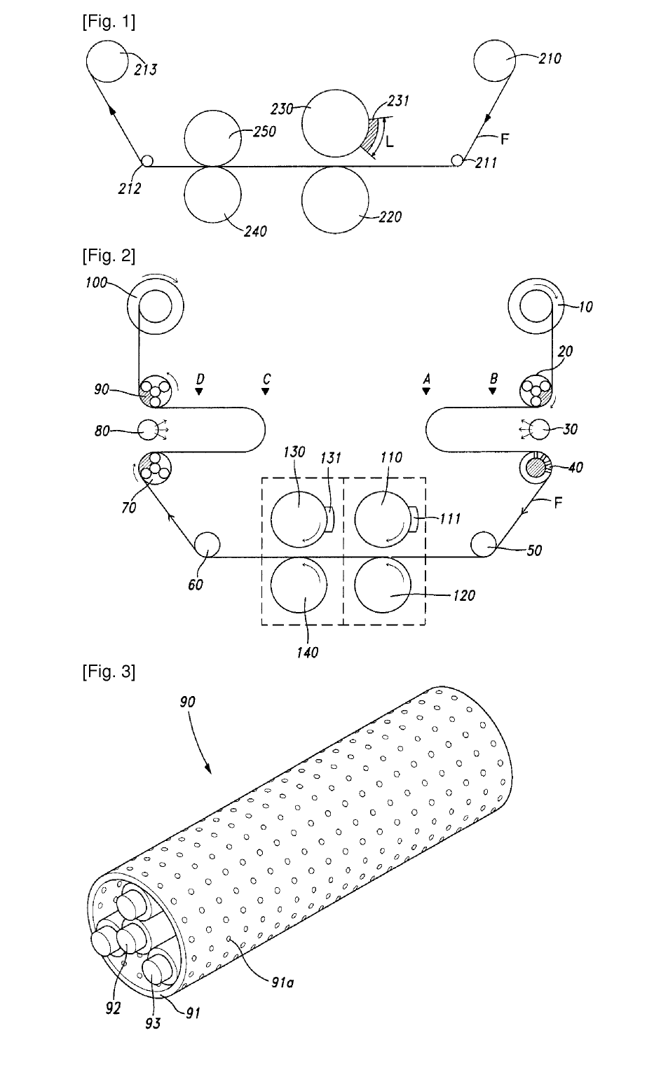

### BEST MODE FOR CARRYING OUT THE INVENTION

FIG. 2 is a schematic view illustrating a printing machine according to the present invention. As shown, a foil F wound in a storage reel 10 is unwound as a storage reel 10 is rotated. The unwound foil F moves to a blower 30 in accordance with guide of a tension adjustment shaft 20. The foil F, which has passed through the tension adjustment shaft 20, is blown by compressed air of the blower 30 at a given length. The foil, which has passed through the blower 30, passes through a suction shaft 40 and then reaches a printing part marked with a dotted line. In the printing part, a die 111 of an impression roller 110 performs printing while the impression roller 110 is rotated in a state that it is engaged with a lower roller 120. Feed rollers 130 and 140 at the rear of the printing part are rotated by being synchronized with the impression roller 110. A die 131 of the feed roller 130 has an arc greater than that of a die 111 of the impression roller 110, and moves the foil F without performing printing. Accordingly, the foil F moves only when foil printing is performed.

The foil F, which has passed through the printing part, reaches a tension adjustment shaft 70 by passing through a general shaft 60, and passes through a tension adjustment shaft 90 through a blower 80, thereby being wound in a winding reel 100.

The foil F, which is blown by the blowers 30 and 80, senses its blowing length to control a motor, which rotates the winding reel 100 and the storage reel 10. In other words, if the foil F blown as printing is performed reaches B from A, the motor of the storage reel 10 is operated to unwind the foil F to allow the foil F to be blown to A. If the foil F blown by the blower 80 reaches D, the winding reel 100 performs winding.

The impression roller 110 of the printing part and the feed roller 130 may be switched with each other in their position.

In order to adjust tension of the foil F, which is wound and unwound, an apparatus for feeding a foil with tension is used.

The apparatus for feeding a foil with tension, as shown in FIG. 3 to FIG. 5, includes a cylindrical shaft body 91 provided with a plurality of holes 91a on the outer surface, a sun roller 92 provided based on the center of the shaft body 91, having a diameter smaller than an inner diameter of the shaft body 91, a plurality of pinion rollers 93 closely adhered to one another between the sun roller 92 and the inner surface of the shaft body 91, and a bearing stopper 94 provided to seal both ends of the shaft body 91 and connected with a pump to supply vacuum pressure to only a space formed by the shaft body 91, the sun roller 92 and two of the pinion rollers 93.

Referring to FIG. 3, the air holes 91a are formed radially in the cylindrical shaft body 91 at constant intervals, and rollers 92 and 93 having the same diameter are provided inside the shaft body 91. The sun roller 92 is provided at the center, and the pinion rollers 93 are provided with one side abutting the sun roller 92 and the other side abutting the inner surface of the shaft body 91. The pinion rollers 93 are provided at intervals of 120.

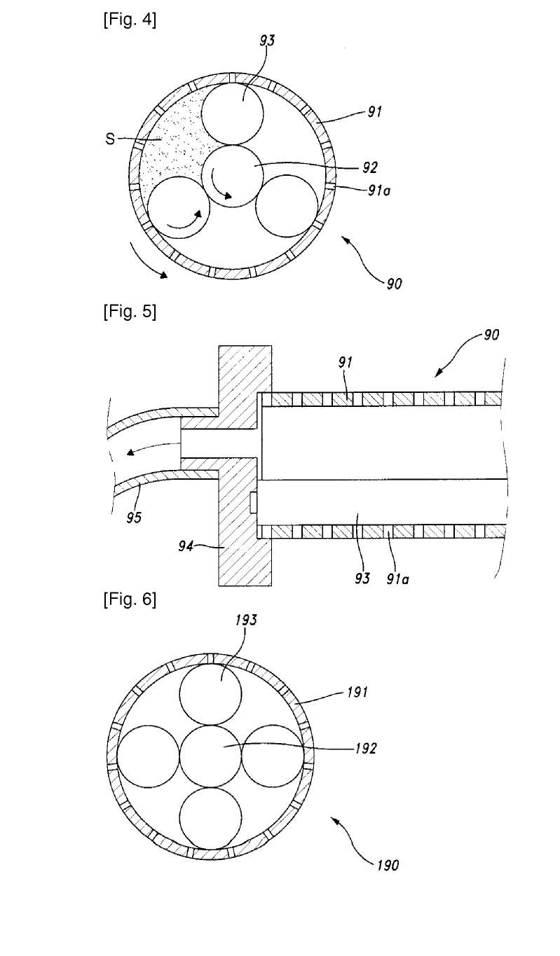

Accordingly, referring to FIG. 4, the inner space of the shaft body 91 is divided into three parts by the shaft body 91 and the rollers 92 and 93, wherein vacuum pressure is only given to a specific space S. This is noted from FIG. 5. A vacuum pump and the space S are connected with the bearing stopper 94, which supports the shaft body 91 and the rollers 92 and 93, through a vacuum hose 95, so that vacuum pressure is supplied to only the specific space S. In this case, as vacuum pressure is supplied to only the specific space S, the foil F is adhered to the outer surface of the shaft body 91 corresponding to the specific space S.

Particularly, referring to FIG. 4, if the shaft body 91 is rotated counterclockwise, the pinion rollers 93 are rotated counterclockwise together with the shaft body 91. In this case, only the sun roller 92 is rotated clockwise. As the shaft body 91 is rotated, feeding is performed by tension and rotation of the foil F adhered to the shaft body 91.

In other words, the shaft 90 serves to tightly maintain the foil F in the winding reel as the shaft body 91 is rotated counterclockwise. The shaft 70 serves to tightly maintain the printing part as it is rotated clockwise. Also, the shaft 20 serves to adjust tension with the storage reel 10 as it is rotated clockwise.

Meanwhile, FIG. 6 is a sectional view illustrating a shaft of an apparatus for feeding a foil of a printing machine with tension according to another embodiment of the present invention. In case of a shaft 190 of FIG. 6, its body 191 and sun roller 192 are identical with those of the aforementioned embodiment. The shaft 190 is different from the aforementioned shafts in that four pinion rollers 193 are arranged at intervals of 90. Accordingly, a part to which the foil is adhered becomes small.

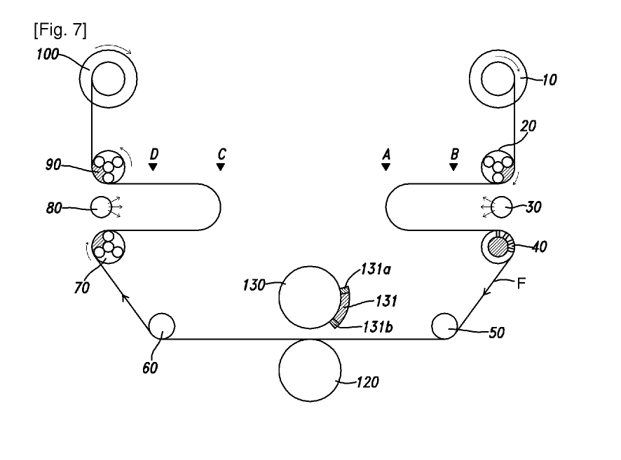

FIG. 7 is a diagram illustrating an apparatus for feeding a foil of a printing machine with tension according to another embodiment of the present invention. Referring to FIG. 7, a feed roller 150 and an impression roller 130 are arranged on the same shaft line. As shown, the feed roller 150 and the impression roller 130 are used in combination. A die 131 is provided with side dies 131a and 131b at its front and rear sides. The side dies may be provided only at a side of the die. Also, the side dies may be provided on other lines not circumferential line.

### INDUSTRIAL APPLICABILITY

The present invention can be used to print a foil in a printing machine.

1. An apparatus for feeding a foil of a printing machine with tension, the apparatus comprising:
a cylindrical shaft body provided with a plurality of holes on the outer surface;
a sun roller provided based on the center of the shaft body, having a diameter smaller than an inner diameter of the shaft body;
a plurality of pinion rollers closely adhered to one another between the sun roller and the inner surface of the shaft body; and
a bearing stopper provided to seal both ends of the shaft body and connected with a pump to supply vacuum pressure to only a space formed by the shaft body, the sun roller and two of the pinion rollers.

2. The apparatus as claimed in claim 1, wherein the pinion rollers are provided at an angle of 120 and the number of them is three.

3. The apparatus as claimed in claim 1, wherein the shaft body is made of metal, and the rollers are made of rubber.

4. An apparatus for feeding a processing material of a foil and diecutting printing machine, the printing machine performing printing or diecutting as the processing material unwound from a storage reel passes between an impression roller attached with a die and a lower roller corresponding to the impression roller, the apparatus comprising a feed roller provided with a die driven at the same circumferential speed as that of the impression roller and the lower roller.

5. The apparatus as claimed in claim 4, wherein the feed roller is provided on the same shaft line as that of the impression roller.
